(19) United States
(12) Patent Application Publication
(10) Pub. No.: US 2005/0175782 A1
(43) Pub. Date: Aug. 11, 2005

(54) Surface technology

(76) Inventor: Thomas M. Graf, Hudson, WI (US)

Correspondence Address: JOEL D. SKINNER, JR.;SKINNER AND ASSOCIATES, 212 COMMERCIAL ST., HUDSON, WI, 54016, US

(21) Appl. No.: 10/774,872

(22) Filed: Feb. 9, 2004

(51) Int. Cl. B05D 3/02; C04B 14/48

(52) U.S. Cl. 427/393.6; 106/712; 106/816; 106/814; 106/817; 106/640; 427/402; 427/331

(57) ABSTRACT

A dry finish composition for producing a monolithic, hard, aesthetic floor or other surface, includes about 30 percent by weight hydraulic cement such as Portland cement, about 20 percent by weight fine aggregate such as silica, and about 50 percent by weight honable aggregate chips. The honable aggregate chips are relatively large particles such as marble, glass or the like, ranging in size from No 0 to No 2. A method of using the dry finish composition to make the floor or other surface, and a resultant floor or other surface are also disclosed.

### 37 C.F.R. §1.71(e) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### CROSS-REFERENCE TO RELATED APPLICATIONS, IF ANY

Not applicable.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND

1. Field

The present invention relates, generally, to surfaces, compositions for surfaces, and surface creation processes. More particularly, the invention relates to cementitious surfaces, compositions for making such surfaces, and methods for making such surfaces. Most particularly, the invention relates to cast in place concrete floor surfaces, concrete floor compositions and concrete floor manufacturing processes, particularly with respect to commercial, industrial and institutional grade flooring. The compositions and methods of the invention may also be useful in other structures, applications and fields, including but not limited to cast in place concrete walls, columns, table tops, countertops, and other structures, and precast structures.

2. Background Information

In general, floors for commercial, industrial and institutional applications or uses can be classified either as “engineered,” “aesthetic” or “standard. Engineered floors generally have performance characteristics that ensure durability, longevity and reliability. Aesthetic floors generally contribute to, and are affirmatively integrated into the creation of the appearance of a building being designed and constructed. Standard floors serve a utilitarian function but are neither engineered or aesthetic.

The choices of floors that have both engineered and aesthetic characteristics (“architectural floors”) have been limited. Granite, quarry tile, and other types of quarried stone are one option. An alternative is terrazzo, which has a comparable look to quarried stone, but which is produced by a relatively complex process by skilled craftspersons. These options are expensive, which limits the types of uses to which they can be put, such as small area floors. Other alternatives which are cheaper, but offer less appealing aesthetic characteristics, include colored concrete floor admixtures which are mixed in wet concrete, colored dry-shake compositions which are shaken or broadcast on wet concrete, and various concrete grinding and polishing methods.

Efforts have been undertaken to create a concrete architectural floor with enhanced aesthetic features. U.S. Pat. No. 5,441,677 to Phillips discloses a method of fabricating a concrete floor having an autogenous hard high gloss finish. In the method, a dry shake dressing material containing quartz crystals and a coloring agent, but no coarse aggregate, is applied to the upper surface of a slab. U.S. Pat. No. 6,016,653 to Shaw, et al. discloses a surface seeded exposed aggregate concrete and forming method. In the method, a concrete mixture is poured over a subgrade and the exposed surface is finished with a vibrating bull float to expose a cement/fines paste derived from the concrete mixture at the exposed surface. A quantity of aggregate is then broadcast upon the exposed surface and mixed into the concrete via the float. The exposed surface is then finished with a power trowel to distribute the aggregate within the cement/fines paste.

The existing technology is believed to have significant limitations and shortcomings. Standard floors constructed of concrete are not hard enough to perform well, nor do they possess sufficient aesthetic characteristics to be considered architectural floors. Floors constructed of concrete and processed with a dry shake or admixture hardener are durable and perform well, but do not meet aesthetic requirements for architectural floors. Quarried stone and terrazzo floors may meet performance and aesthetic standards, but they are very expensive. For these and other reasons, a need exists for the present invention.

The present invention provides a floor that has comparable, or for some features, better aesthetic characteristics than current alternatives for architectural floors; that has comparable or better performance characteristics than the current alternatives for architectural floors; and that can be produced in a consistent, cost-effective manner. Thus, the technology of the invention can be utilized to create an engineered aesthetic floor in situations where the cost of the alternatives, e.g. large areas, would force compromise in the flooring choices.

All U.S. patents and patent applications, and all other published documents mentioned anywhere in this application are hereby incorporated by reference in their entirety.

### BRIEF SUMMARY

The present invention provides a concrete surface composition, a method of making a concrete surface, and a resultant concrete surface, which are practical, reliable, durable, efficient, and attractive, and which are believed to fulfil a need and to constitute an improvement over the background technology.

In the composition aspect, the invention provides a composition for producing a surface (for example a floor), comprising a hydraulic cement (for example Portland cement), fine aggregate (for example silica), and honable aggregate chips (for example relatively large marble or other chips).

In the method aspect, the invention provides a method of producing a smooth, hard and aesthetic surface, comprising the steps of:
a. pouring a concrete substrate of a predetermined area and thickness;
b. distributing a finish composition comprising a hydraulic cement, fine aggregate, and honable aggregate chips over the concrete substrate while the concrete substrate has a predetermined degree of wetness;
c. permitting the concrete substrate and distributed finish composition to cure, and
d. honing the cured surface.

In the surface aspect, the invention provides a monolithic, hard, aesthetic surface, comprising a standard concrete substrate of a predetermined area and thickness and a top surface, integral with the concrete substrate, comprising a hydraulic cement, fine aggregate, and honable aggregate chips.

Although the discussion of the compositions, methods and structures in this summary has been in the context of a floor, it will be apparent to those skilled in the art that the compositions, methods and structures of the invention may also be useful in other structures, applications and fields, including but not limited to cast in place concrete walls, stairs, columns, table tops, countertops, and other structures, and precast structures.

The features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 shows examples of honable aggregate chips of the composition of the invention.

FIG. 2 illustrates size differences of honable aggregate chips.

FIG. 3 is a flow chart illustrating an embodiment of the method of using the composition of the invention to make the surface of the invention.

FIG. 4 is a crossectional illustration of an embodiment of a surface of the invention, which is produced by the composition and method of the invention.

FIGS. 5a-k are plan views showing embodiments of surfaces of the invention.

### DETAILED DESCRIPTION

1. Surface Finish Composition.

The invention provides a composition for producing a monolithic, high performance (hard), highly attractive surface, such as a floor, table top, countertop or the like. The composition is added at a finish stage to an existing substrate of standard concrete placed or deposited on a grade or other substrate, and which is wet but in the process of drying. The finish composition is preferably dry and is added preferably by broadcasting it over the surface of the wet concrete. In the preferred embodiment, the finish composition is not pre-added or integrally mixed with the concrete.

Concrete, for example ready-mixed concrete, is a well known mixture of a paste of Portland cement (typically 10-15 percent) and water (15-20 percent), and a mixture of fine and course (natural gravel and crushed rock) aggregate (60-75 percent). Fine aggregate such as natural sand and crushed rock, has particle sizes less than 3/8 inch in maximum dimension. Course aggregate, such as natural gravel and crushed stone, generally range between ⅜ and 1.5 inches in maximum dimension. Entrained air in some concrete mixes may also make up another 5-8 percent. Small amounts of chemical or mineral admixtures (such as air-entraining, water-reducing, retarding, accelerating, plasticizing and specialty category admixtures) may also be added to the concrete immediately before or during mixing. The Portland cement and water paste component of concrete coats the surface of the aggregate grains or particles and fills the voids therebetween. The concrete mixture sets and hardens through a chemical reaction, known as hydration, between the Portland cement and water in the paste. The aggregate component of concrete reduces shrinkage and increases economy. The mixture of fine to course aggregates is dependent primarily upon workability (i.e. spreadability, pumpability) of the concrete mixture and somewhat dependent upon the durability of the hardened concrete. The admixture component or components of concrete are added primarily to reduce cost, modify properties of placed or hardened concrete, and to overcome certain emergencies during placement. The mixture of the elements of concrete are varied mainly to provide a desired level of structural strength and workability, as opposed to surface hardness and decoration.

The finish composition of the invention provides both a harder surface, for example a floor surface, than that provided by concrete alone, and, at the same time, it provides a more decorative finish than concrete alone, or concrete with standard dry shake surface hardeners.

The finish composition comprises, in general, a hydraulic cement, fine aggregate, and honable aggregate chips. The combination of the hydraulic cement and fine aggregate components in the overall composition primarily serves to provide a hard, durable flat surface of a predetermined thickness when applied to the wet concrete substrate. The honable aggregate chips in the overall composition serve to provide a decorative appearance of the surface. The composition provides a surface which is monolithic, that is to say that it is uniform and has the appearance of being made of one single piece.

The first main element of the composition is hydraulic cement. The preferred hydraulic cement in the composition is Portland cement. Examples of Portland cements include Type I, II and III gray and white Portland cements which comply with ASTM C150. Portland cement is a well known type of hydraulic cement which is made by burning a mixture of limestone and clay, and is a basic ingredient of concrete. It contains calcium, silicon, aluminum, and iron, to which gypsum is added in a final grinding process to regulate the setting time of concrete. It functions to provide adherence with other elements of the composition and to provide a hardness and durability characteristics to the surface. Several varieties of Portland cement exist, including white, gray, and subvarities thereof. The choice of Portland cement in redi-mix concrete for example, depends upon a variety of structural, cost, availability, and other factors. The hydraulic cement in the composition of the present invention is provided in an amount between approximately 25 and 35 percent by weight, and preferably 30 percent by weight.

The second main element of the composition is fine aggregate. The preferred fine aggregate in the composition, is silica. Silica is preferably provided in the form of silica sand. The dioxide form (SiO₂) of Silicon (Si), silica is typically found in the form of quartz (quartz sand). Alternative fine aggregates include marble, limestone, granite and glass. Fine aggregate comprises between 15 and 25 percent, preferably 20 percent by weight of the composition. Fine aggregates are particles in size not greater then 1/16 inch in largest dimension. Particles between 1/32 and 1/16 inch are commonly referred to as 00 mesh size.

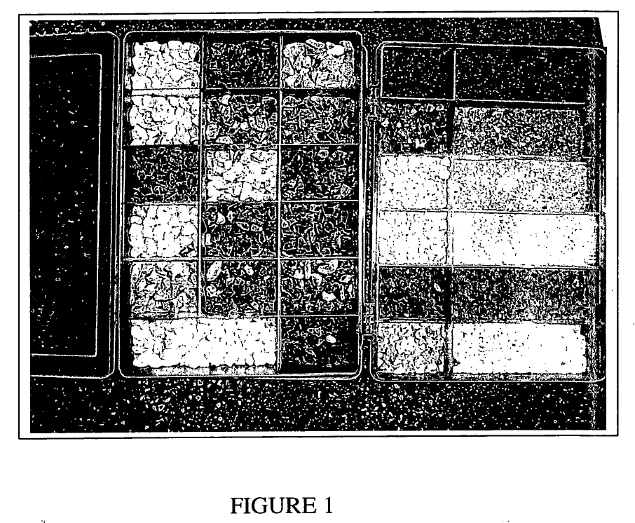

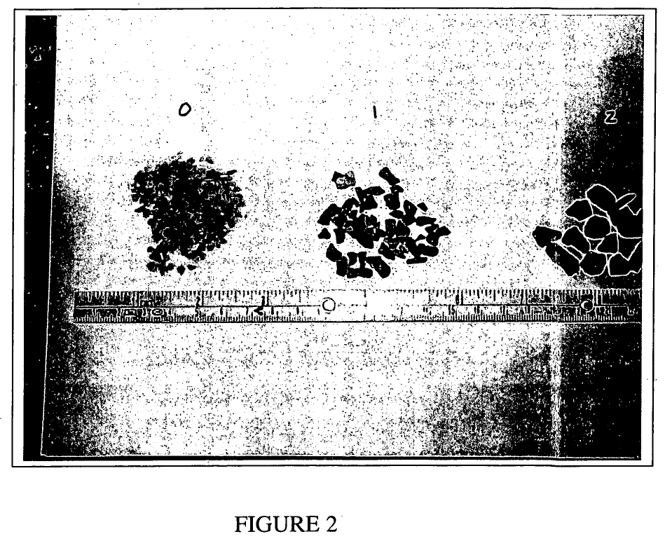

The third main element of the composition of the invention is honable aggregate chips. The honable aggregate chips are uniformly mixed in the composition. The honable aggregate chips are provided in an amount approximately between 40 and 60 percent by weight, and preferably 50 percent by weight. The honable aggregate chips are preferably include marble (again, the crystalline form of limestone or calcium carbonate). Alternative honable aggregate chips include carbide silica, limestone, granite, onyx, glass, metal, and the like. The honable aggregate chips are opaque or translucent. The honable aggregate chips may be colored as shown in FIG. 1. Importantly, the honable aggregate chips are relatively large No. 0, No. 1, and No. 2 Size (sieve fraction) particles. Referring to FIG. 2, No. 0 size particle range from about 1/16 to 1/8 inch in largest dimension. No. 1 size particles range from about ⅛ to 1/4 inch in largest dimension. No. 2 size particles range from about ¼ to 3/8 inch in largest dimension. Thus, honable aggregate chips range in size from approximately 1/8 to 3/8 inch in dimension. No. 0 chips are provided in an amount from 35 to 45, preferably 40, percent by weight of the overall composition. No. 1 size chips are provided in an amount from 5 to 7, preferably 6, percent by weight of the overall composition. And No. 2 size chips are provided from 3 to 5, preferably 4 percent by weight of the overall composition.

Although particle size is well known to influence the properties of freshly mixed concrete, applicant has recognized that size is important with respect to the properties and aesthetics of the hardened concrete as well, and applicant has utilized this finding to provide an optimal composition. The large honable chips of the composition provide an optimum honing component to the floor and generate a high quality aesthetic finish in the completed floor.

In addition to comprising the principal components of hydraulic cement, fine aggregate and honable aggregate chips, the composition may include relatively small amounts of other elements such as plasticizers, colorants, and admixtures. The total amount of such elements typically is less than 1 percent by weight of the overall composition. Plasticizer functions to impart workability to the remaining elements of the composition with relatively little water. Colorant or pigment functions to provide a predetermined amount of color. Examples of colorants include iron oxide (FeO₂) and titanium dioxide. Examples of admixtures include water reducers such as lignosulfonate, naphtalene sulfonate formaldehyde condensate, and melamine sulfonate formaldehyde condensate or polycarboxylate.

### EXAMPLE 1

The following is a non-limiting example of the composition of the present invention. The following constituents are mixed together uniformly and yielded approximately 100 pounds of composition.

| | | |
|---|---|---|
| Portland Cement | 30 | pounds |
| Silica Sand | 20 | pounds |
| No. 0 Marble Chips | 40 | pounds |
| No. 1 Marble Chips | 7 | pounds |
| No. 2 Marble Chips | 3 | pounds |
| Plasticizer | less than 1 | pound |
| Fe0₂ | less than 1 | pound |

In summary, the resultant finish composition of the present invention preferably contains about 30 percent by weight hydraulic cement, about 20 percent by weight fine aggregate, about 50 percent by weight honable aggregate chips, and less than 1 percent by weight ancillary constituents such as plasticizer, colorants and the like. The composition of the present invention provides sufficient density in the surface to yield required hardness and durability, and at the same time provides a uniform distribution of aggregate to meet high aesthetic requirements.

### EXAMPLE 2

The following is another non-limiting example of the composition of the present invention. The following constants are mixed together uniformly and yielded approximately 100 pounds of composition.

| | | |
|---|---|---|
| Portland Cement | 30 | pounds |
| Silica Sand | 20 | pounds |
| No. 00 Marble Chips | 15 | pounds |
| No. 0 Marble Chips | 5 | pounds |
| No. 1 Marble Chips | 25 | pounds |
| No. 2 Marble Chips | 5 | pounds |
| Plasticizer | less than 1 | pound |
| Fe0₂ | less than 1 | pound |

In summary, the resultant finish composition of the present invention preferably contains about 30 percent by weight hydraulic cement, about 20 percent by weight fine aggregate, about 50 percent by weight honable aggregate chips, and less than 1 percent by weight ancillary constituents such as plasticizer, colorants and the like. The composition of the present invention provides sufficient density in the surface to yield required hardness and durability, and at the same time provides a uniform distribution of aggregate to meet high aesthetic requirements.

2. Method of Using the Composition.

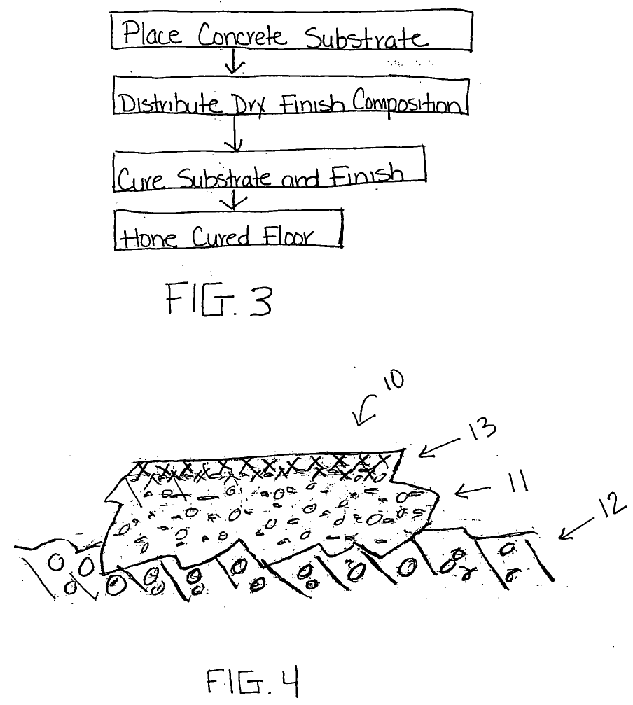

The invention also provides a method of producing a surface, for example a floor, utilizing the composition of the invention. Referring to FIG. 3, an embodiment of the method comprises the basic steps of:
a. pouring a concrete substrate of a predetermined area and thickness;
b. providing a finish composition comprising a hydraulic cement, fine aggregates, and honable aggregate chips;
c. distributing the finish composition over the concrete substrate while the concrete substrate has a predetermined degree of wetness;
d. permitting the concrete substrate and dry finish composition to cure; and
e. honing the cured surface.

A base of concrete is placed by pouring, pumping or other means at a predetermined location. Pouring is preferably accomplished at a slump rate not in excess of 5 inches for a slab on grade. After placement, the surface is screed and strikeoff to proper contour and elevation, and bullfloated to eliminate high and low spots, and to embed large aggregate particles. Bleed water is allowed to rise to the surface. Moisture loss and setting is monitored for timing of floating. Any standing water should be removed by a conventional method. Upon disappearance of water sheen on the surface, the surface is floated open, preferably with a mechanical float fitted with float shoes. Floating embeds aggregate particles just beneath the surface, removes slight imperfections, humps and voids, and compacts the mortar at the surface.

A predetermined amount of finish composition of the present invention, which is preferably dry, is uniformly distributed across the surface, preferably via an automatic spreader such as a TEREX MORRISON MS 40 Materials Spreader or a telescopic spreader.

The finish composition preferably contains about 30 percent by weight hydraulic cement (preferably Portland cement), about 20 percent by weight fine aggregate (preferably silica), about 50 percent by weight honable aggregate chips (preferably large No. 0-2 marble or other chips), and less than 1 percent by weight ancillary constituents such as plasticizer, colorants and the like. The combination of hydraulic cement and fine aggregate primarily serves to provide a hard, durable flat surface. The honable aggregate chips serve to add or improve the decorative appearance of the surface. The composition provides sufficient density in the surface to yield required hardness and durability, and at the same time provides a uniform distribution of aggregate to meet high aesthetic requirements.

The distributed surface is permitted to absorb a sufficient amount of moisture whereby the surface darkens somewhat. The surface is then floated to incorporate the dry finish into the surface, preferably with a floating machine with flat shoes or with a wood bullfloat. Edges should be hand floated with a wood float or a darby.

Immediately after this step, a second pass of a predetermined amount, preferably approximately one half to one third the amount of dry finish initially distributed, of dry finish, is uniformly distributed across the surface. Upon absorption of sufficient moisture whereby the surface darkens, the surface is floated again. A third application of dry finish may optionally be applied. One or more mechanical trowellings are preferably conducted after the surface has lost its sheen and can support the weight of a finishing machine and its operator. Troweling aids in creating a smooth, hard and dense surface.

After trowlling is completed, a membrane curing compound may be applied. After drying, building paper or polyethylene may be applied to cover the surface for protection during final curing. Curing aids the hydration reaction. The surface should be kept free of traffic and loads for approximately 10 days at a temperature between 50 and 75 degrees F.

A joint filler material may be placed in any control and saw cut construction joints. Sealer may be placed on the surface.

After curing, a period of from 2 weeks to one year, the floor is honed. Honing is preferably accomplished with a planetary grinder. Honing involves a multi-step (for example, nine (9) steps) sequential honing process starting with about 40 grit and proceeding to about 3000 grit honing materials. Chemical hardeners, stain resistant surface impregnators, and other compounds may be used as part of the honing process.

3. A Surface Provided by the Composition and Methods.

The invention provides a monolithic, high performance or hard, highly attractive surface, such as a floor. The floor or other surface has a harder finish surface than that provided by concrete alone, and it provides a more decorative finish than concrete alone, or concrete with standard dry shake finish surface hardeners.

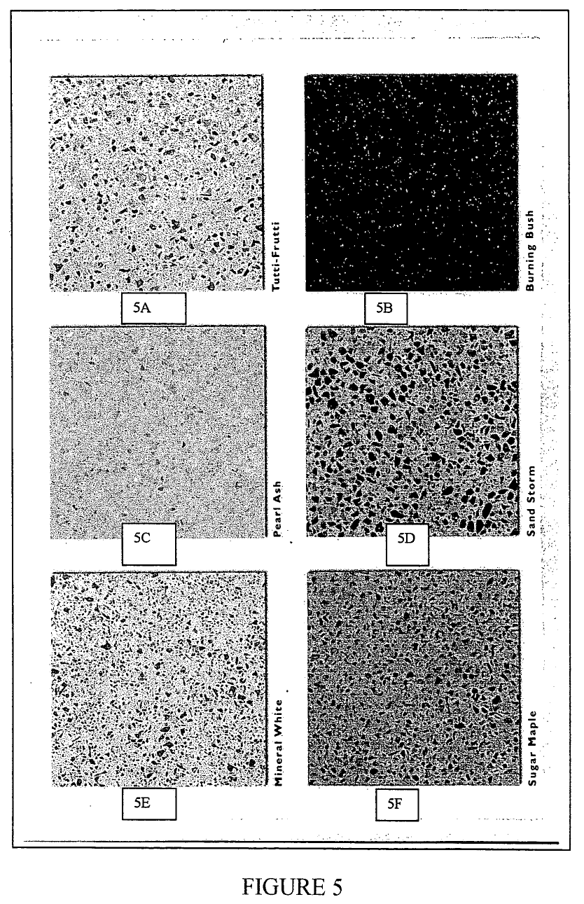

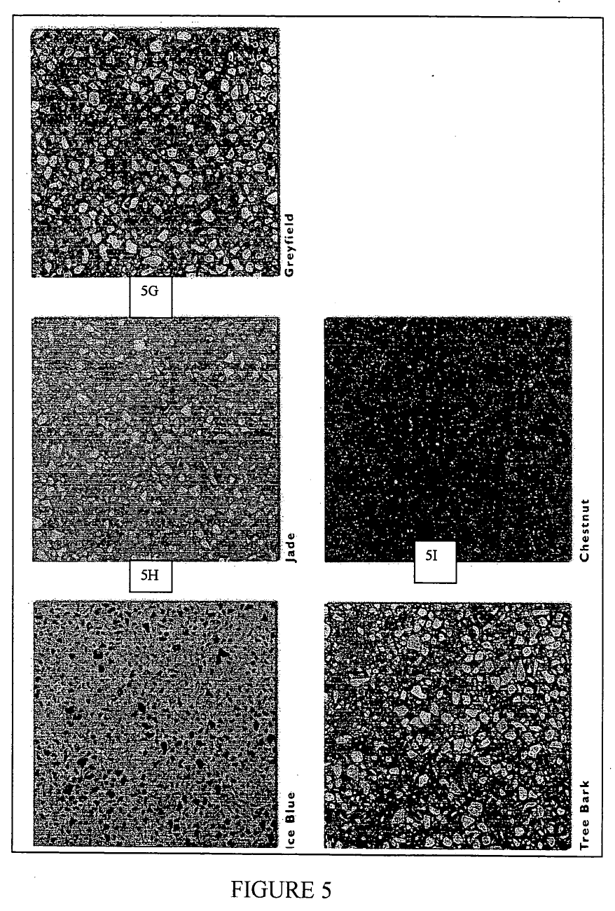

Referring to FIGS. 4 and 5a-k, the floor 10 comprises, in general, a standard concrete substrate 11 of a predetermined area and thickness, which is deposited on a grade 12, and a top surface 13, integral with the concrete substrate 10.

The top surface area 13 preferably contains about 30 percent by weight hydraulic cement (preferably Portland cement), about 20 percent by weight fine aggregate (preferably silica), about 50 percent by weight honable aggregate chips (preferably large No. 0-2 marble or other chips), and less than 1 percent by weight ancillary constituents such as plasticizer, colorants and the like. The top grade 13 provides sufficient density in the surface to yield required hardness and durability, and at the same time provides a uniform distribution of aggregate to meet high aesthetic requirements. The combination of hydraulic cement and fine aggregate primarily serves to provide a hard, durable flat surface on the concrete substrate 11. The honable aggregate chips serve to add or improve the decorative appearance of the floor 10. The floor 10 or other surface of the invention is monolithic, that is to say that it is uniform and has the appearance of being made of one single piece.

The floor structure 10 of the invention has a sufficient density in the surface to yield required hardness and durability, and at the same time provides a uniform distribution of aggregate to meet aesthetic requirements.

Although the invention has been described in connection with the field of floors, it can readily be appreciated that the is not limited solely to such field, and can be used in other fields including, but not limited to floor coverings, walls, ceilings, roofs, columns, table tops counter tops, cast in place structures and articles, pre-cast articles and structures, compositions, methods, and structures or articles and the like.

The descriptions above and the accompanying drawings should be interpreted in the illustrative and not the limited sense. While the invention has been disclosed in connection with an embodiment or embodiments thereof, it should be understood by those skilled in the art that there may be other embodiments which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

1. A composition comprising, a hydraulic cement, fine aggregate, and honable aggregate chips.

2. The composition of claim 1, wherein the hydraulic cement comprises approximately 25 to 35 percent by weight of the composition.

3. The composition of claim 2, wherein the hydraulic cement comprises 30 percent by weight of the composition.

4. The composition of claim 1, wherein the hydraulic cement is Portland cement.

5. The composition of claim 4, wherein the fine aggregate comprises approximately 15 to 25 percent by weight of the composition.

6. The composition of claim 5, wherein fine aggregate comprises 20 percent by weight of the composition.

7. The composition of claim 1, wherein the fine aggregate is silica.

8. The composition of claim 1, wherein the honable aggregate chips are uniformly mixed with the base mixture.

9. The composition of claim 1, wherein the honable aggregate chips comprises approximately 40 to 60 percent by weight of the composition.

10. The composition of claim 9, wherein the honable aggregate chips comprises 50 percent by weight of the composition.

11. The composition of claim 1, wherein the honable aggregate chips are selected from the group of materials consisting of marble, glass, metal, limestone, granite or onyx.

12. The composition of claim 1, wherein the honable aggregate chips are at least No. 0 size chips.

13. The composition of claim 12, wherein the honable aggregate chips include No. 0, No. 1 and No. 2 size chips.

14. The composition of claim 13 wherein the honable aggregate chips include approximately 40 percent by weight of the composition No. 0 size chips.

15. The composition of claim 13 wherein the honable aggregate chips include approximately 6 percent by weight of the composition No. 1 size chips.

16. The composition of claim 13 wherein the honable aggregate chips include approximately 4 percent by weight of the composition No. 2 size chips.

17. The composition of claim 1, wherein the composition comprises about 30 percent by weight hydraulic cement, about 20 percent by weight fine aggregate, and about 50 percent by weight honable aggregate chips.

18. The composition of claim 1 wherein the honable aggregate chips include approximately 40 percent by weight of the composition No. 0 size chips, approximately 6 percent by weight of the composition No. 1 size chips, and approximately 4 percent by weight of the composition No. 2 size chips.

19. The composition of claim 1, further comprising at least one element selected from the group of elements consisting of a plasticizer, and a colorant.

20. The composition of claim 1, for use as a dry finish with a wet concrete substrate to harden and create an aesthetic surface for the concrete substrate.

21. A method of producing a surface, comprising the steps of:
a. placing a concrete substrate of a predetermined area and thickness;
b. distributing a finish composition, comprising hydraulic cement, fine aggregate and honable aggregate chips, uniformly over the concrete substrate while the concrete substrate has a predetermined degree of wetness;
c. finishing the concrete substrate and finish composition;
d. waiting for the concrete substrate and finish composition to cure to thereby yield a cured surface; and
e. honing the cured surface.

22. The method of claim 21, wherein the concrete substrate is pumped, placed or otherwise conveyed or poured to or at a predetermined location.

23. The method of claim 22, wherein pouring is accomplished at a slump rate not in excess of 5 inches for a slab on grade.

24. The method of claim 21, wherein after placement of the concrete substrate, and prior to distribution, the surface is screed and bullfloated/highway straightedged, bleed water is allowed to rise to the surface, moisture loss and setting is monitored for timing of floating, any standing water is removed, and upon disappearance of water sheen on the surface, the surface is floated open.

25. The method of claim 21, wherein a predetermined amount of dry finish composition is uniformly distributed across the surface.

26. The method of claim 25, wherein distribution is implemented via an automatic spreader.

27. The method of claim 21, wherein, after distribution, the surface is permitted to absorb a sufficient amount of moisture, the surface is then floated to incorporate the dry finish composition into the surface.

28. The method of claim 27, wherein, after the last floating, a predetermined amount, between approximately one half to one third the amount of dry finish initially distributed, of dry finish is uniformly distributed across the surface, and upon absorption of sufficient moisture, the surface is floated again. A third application of dry finish may optionally be applied.

29. The method of claim 21, wherein one or more mechanical trowellings are conducted after the surface has lost its sheen and can support the weight of a finishing machine and its operator.

30. The method of claim 21, wherein the step of honing the surface is accomplished with a planetary grinder.

31. A monolithic, hard, aesthetic architectural surface comprising a standard concrete substrate of a predetermined area and thickness and a top surface, integral with the concrete substrate, comprising a hydraulic cement, fine aggregate, and honable aggregate chips.

32. The surface of claim 31, wherein the hydraulic cement is provided in an amount approximately 30 percent by weight, wherein the fine aggregate is provided in amount approximately 20 percent by weight, and wherein the honable aggregate chips are provided in an amount approximately 50 percent by weight.

33. The surface of claim 31 wherein the surface further comprises at least one element selected from the group of elements consisting of a plasticizer, and a colorant.

34. The surface of claim 31, wherein the honable aggregate chips are selected from the group of aggregates consisting of marble, glass, metal, limestone, granite and onyx.

35. The surface of claim 31, wherein the honable aggregate chips are at least No. 0 Size.

36. The surface of claim 31, wherein the surface is a floor.

37. The surface of claim 31, wherein the surface is a table top.
